(19) United States
(12) Patent Application Publication
(10) Pub. No.: US 2017/0157884 A1
(43) Pub. Date: Jun. 8, 2017

(54) POROUS AEROSTATIC CARRIER AND POROUS BODY THEREIN

(71) Applicant: METAL INDUSTRIES RESEARCH & DEVELOPMENT CENTRE, Kaohsiung City 811 (TW)

(72) Inventors: Hsiang-Pin Wang, Kaohsiung City (TW); Kuo-Yu Chien, Kaohsiung City (TW); Fu-Chuan Hsu, Kaohsiung City (TW)

(21) Appl. No.: 14/982,084

(22) Filed: Dec. 29, 2015

(30) Foreign Application Priority Data
Dec. 8, 2015 (TW) 104141211

(51) Int. Cl. B32B 3/26; B33Y 10/00; B23K 26/342; B33Y 80/00; B23K 15/00

(52) U.S. Cl. CPC B32B 3/26; B33Y 80/00; B23K 15/0086; B23K 26/342; B33Y 10/00; B32B 2307/724

(57) ABSTRACT

A porous aerostatic carrier includes a porous body made by additive manufacturing method and a sealing layer, the porous body comprises a first ventilating portion and a second ventilating portion, and a first porosity of the first ventilating portion is higher than a second porosity of the second ventilating portion. Because of additive manufacturing method, pore size and porosity of the first ventilating portion and the second ventilating portion are controllable to make flow pressure passing through the porous aerostatic carrier distributing evenly.

### FIELD OF THE INVENTION

The present invention relates to a porous aerostatic carrier and a porous body therein, particularly represents the porous body being made by additive manufacturing method to control pore size and porosity of the porous body.

### BACKGROUND OF THE INVENTION

A conventional porous aerostatic bearing made of metallic powder, ceramic powder or graphite powder is manufactured by molding and sintering of powder metallurgy. Therefore, pore size of the porous aerostatic bearing is not controllable because of various particle sizes of mentioned powders. Accordingly, porosity and permeability of the porous aerostatic bearing are uneven to make outlet air or fluid pressure of the porous aerostatic bearing distributing unevenly.

When the porous aerostatic bearing is mounted on a carrying stage, the carrying stage moving along a track will shack easily because of uneven outlet air pressure of the porous aerostatic hearing to affect moving stability of the carrying stage.

### SUMMARY

The primary object of the present invention is to provide a porous aerostatic carrier including a porous body made by additive manufacturing method and a sealing layer. The porous body comprises a first ventilating portion and a second ventilating portion. The first ventilating portion includes a plurality of first pores, the second ventilating portion includes a plurality of second pores communicating with the first pores, and a first porosity of the first ventilating portion is higher than a second porosity of the second ventilating portion. The sealing layer covers the second ventilating portion and comprises a plurality of through holes which reveal parts of the second pores.

The primary object of the present invention is to provide a porous body made by additive manufacturing method. The porous body comprises a first ventilating portion and a second ventilating portion. The first ventilating portion includes a plurality of first pores, the second ventilating portion includes a plurality of second pores communicating with the first pores, and a first porosity of the first ventilating portion is higher than a second porosity of the second ventilating portion.

The porous body of the present invention is made by additive manufacturing method for controlling pore sizes of the first pores of the first ventilating portion and the second pores of the second ventilating portion, and making the first porosity of the first ventilating portion being higher than the second porosity of the second ventilating portion thus making outlet air or fluid pressure of the porous aerostatic carrier distributing evenly.

### DESCRIPTION OF THE DRAWINGS

FIGS. 1 to 4 are manufacturing schematic drawings illustrating a porous aerostatic carrier in accordance with the present invention.

FIGS. 5A and 5B are schematic drawings illustrating a polygon mesh structure of a porous body in accordance with the present invention.

FIGS. 6A and 6B are schematic drawings illustrating a body-centered cubic structure of the porous body in accordance with the present invention.

FIGS. 7A and 7B are schematic drawings illustrating a face-centered cubic structure of the porous body in accordance with the present invention.

FIG. 8 is a schematic drawing illustrating a circular cubic structure of the porous body in accordance with the present invention.

FIG. 9 is a schematic drawing illustrating a rectangular cubic structure of the porous body in accordance with the present invention.

FIG. 10 is a schematic drawing illustrating the porous aerostatic carrier in accordance with the present invention.

FIG. 11 is a schematic drawing illustrating the porous aerostatic carrier utilized on a shaft in accordance with the present invention.

### DETAILED DESCRIPTION OF THE INVENTION

With reference to FIG. 4, a porous aerostatic carrier 100 in accordance with a first embodiment of the present invention is able to be utilized in precision equipments such as carrying stage of optoelectronic semiconductor exposing machine, carrying stage of precise processing machine, positioning stage of measuring equipment, precision bearing and so on.

With reference to FIG. 4, the porous aerostatic carrier 100 includes a porous body 110 and a sealing layer 120, wherein the porous body 110 is made by additive manufacturing method selected from select laser melting (SLM), electron beam melting (EBM), direct metal deposition (DMD) and 3D printing.

With reference to FIGS. 1 to 4, the manufacturing method of the porous aerostatic carrier 100 is illustrated in mentioned Figures. First, referring to

FIG. 1, forming a first ventilating portion 111 by additive manufacturing method, wherein the material of the first ventilating portion 111 is selected from metallic materials such as aluminum alloy, stainless steel, die steel, titanium alloy, nickel alloy, copper alloy and cobalt-chromium alloy. The first ventilating portion 111 includes a plurality of first pores 111a and a first surface 111b, wherein pore size of the first pores 111a is between 100 um and 300 um in this embodiment. Flowing direction and pore size of the first pores 111a are controllable owing to the first ventilating portion 111 being made by additive manufacturing method. Besides, the first ventilating portion 111 has a first porosity, wherein the first porosity is between 0.3 and 0.4 in this embodiment.

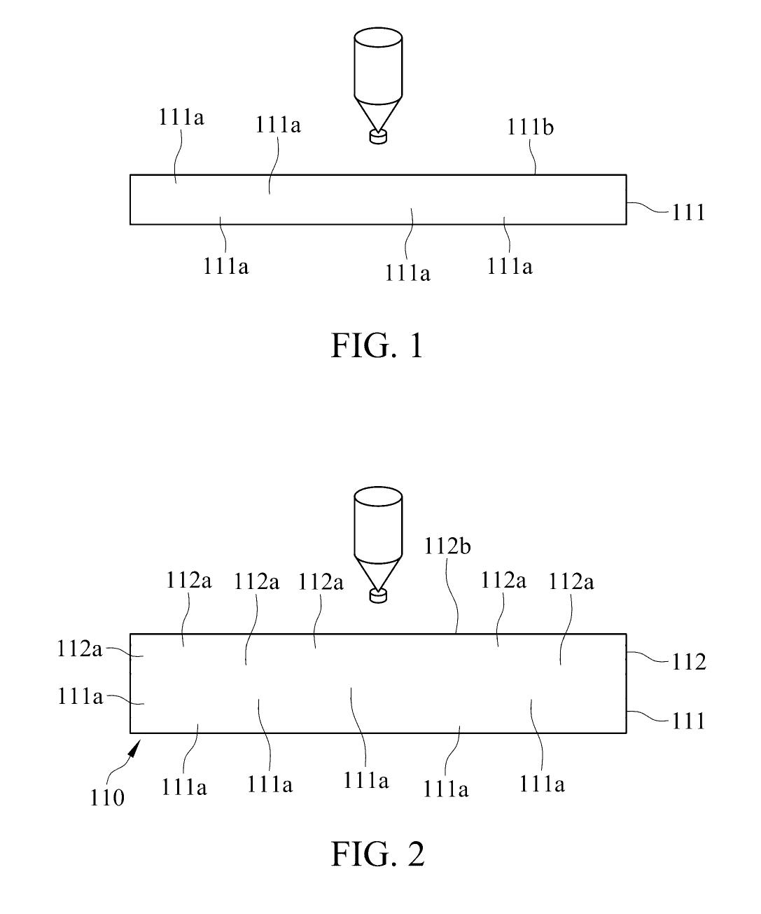

Next, referring to FIG. 2, forming a second ventilating portion 112 by additive manufacturing method, wherein the material of the second ventilating portion 112 is selected from metallic materials such as aluminum alloy, stainless steel, die steel, titanium alloy, nickel alloy, copper alloy and cobalt-chromium alloy. The second ventilating portion 112 includes a plurality of second pores 112a, wherein pore size of the second pores 112a is between 100 um and 300 um in this embodiment. Flowing direction and pore size of the second pores 112a are controllable owing to the second ventilating portion 112 being made by additive manufacturing method. The second ventilating portion 112 is &tuned on the first surface 111b of the first ventilating portion 111 and comprises a second porosity and a second surface 112b, wherein the first pores 111a communicate with the second pores 112a.

In this embodiment, the first porosity of the first ventilating portion 111 is higher than the second porosity of the second ventilating portion 112, wherein the second porosity is between 0.15 and 0.25, and pore sizes of the first pores 111a and the second pores 112a are substantially the same. The first porosity enables to be defined by Vv1/Vt1 in advance (Vv1 is the volume of the first pores 111a, Vt1 is the apparent volume of the first ventilating portion 111), and the second porosity enables to be defined by Vv2/Vt2 in advance (Vv2 is the volume of the second pores 112a, Vt2 is the apparent volume of the second ventilating portion 112).

With reference to FIG. 2, a plurality of micro channels are composed of the first pores 111a and the second pores 112a communicating with the first pores 111a and flowing direction of the micro channels are pre-designed when forming the first ventilating portion 111 and the second ventilating portion 112. Preferably, the first ventilating portion 111 and the second ventilating portion 112 are formed as one piece, and the materials of the first ventilating portion 111 and the second ventilating portion 112 are the same.

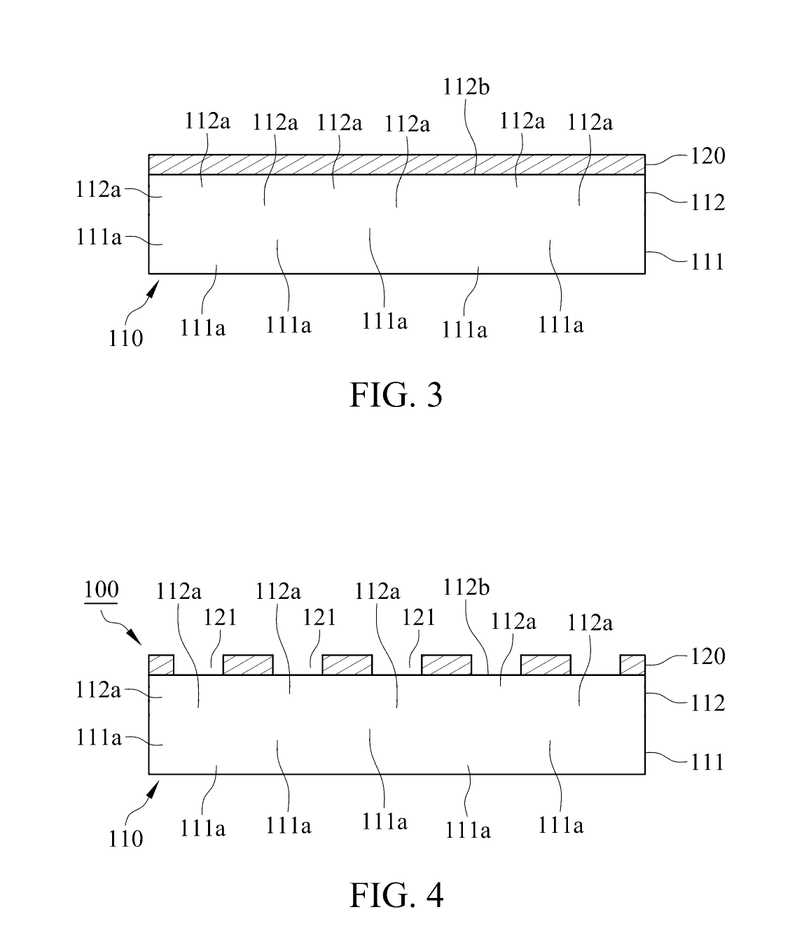

After that, with reference to FIG. 3, the sealing layer 120 covers the second surface 112b of the second ventilating portion 112, wherein the material of the sealing layer 120 is selected from epoxy and polyimide. In this embodiment, the sealing layer 120 covers the second surface 112b of the second ventilating portion 112 to seal openings of the second pores 112a located on the second surface 112b via vacuum compression molding, leveling and baking. Eventually, with reference to FIG. 4, forming a plurality of through holes 121 within the sealing layer 120 by laser drilling, wherein the through holes 121 reveal parts of the second pores 112a, and the micro channels for flow deliver are composed of the first pores 111a, the second pores 112a and the through holes 121 communicating with each others. In other embodiment, the through holes 121 are formed within the sealing layer 120 in advance, then the sealing layer 120 with the through holes 121 covers the second surface 112b of the second ventilating portion 112. Or, in other embodiment, the sealing layer 120 is also made by additive manufacturing method, and the through holes 121 are formed at the same time. In present invention, the forming method and material of the sealing layer 120 and the forming method of the through holes 121 are not constrained.

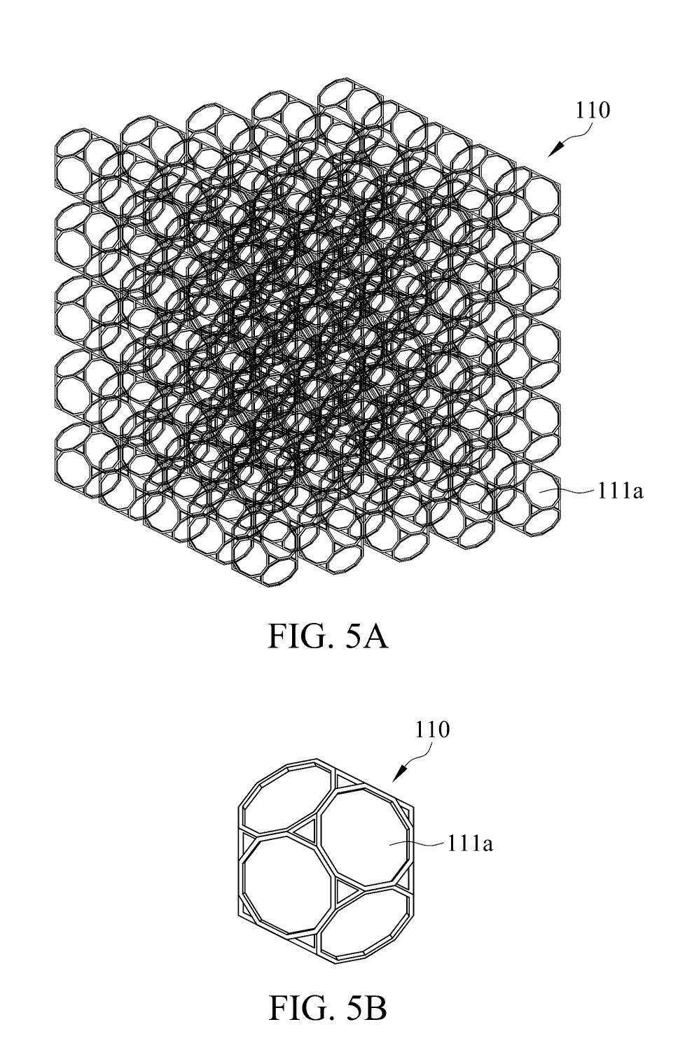

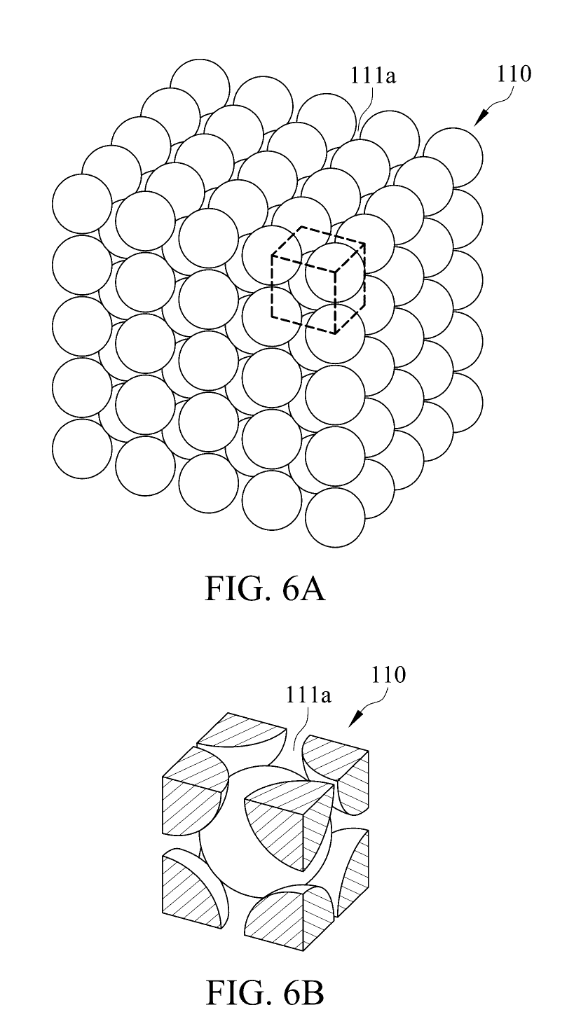

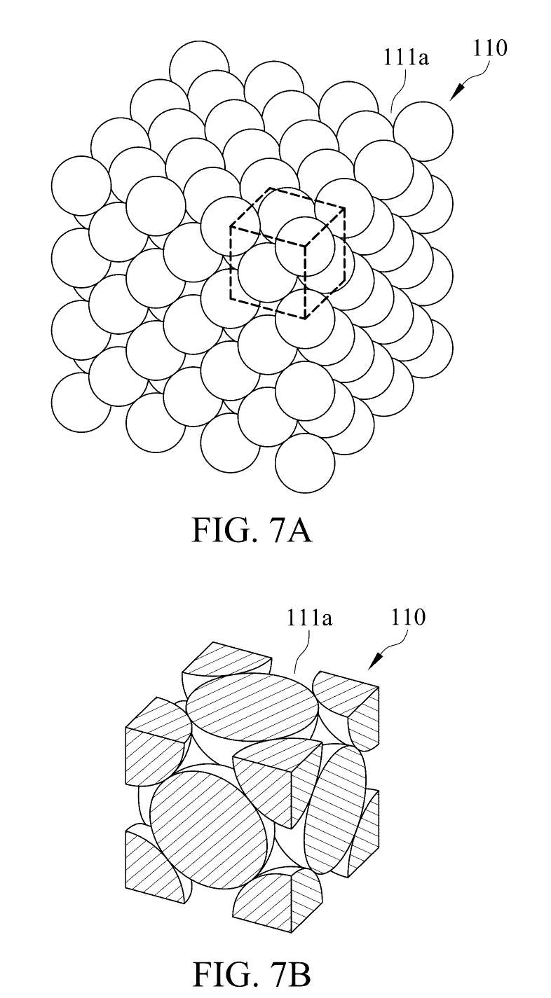

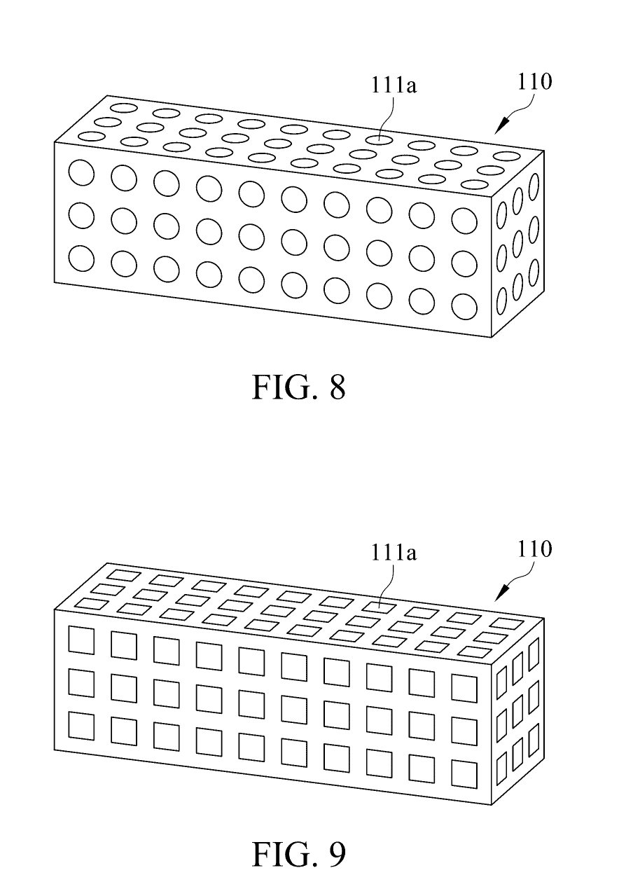

With reference to FIGS. 5A to 8, the structures of the first ventilating portion 111 and the second ventilating portion 112 are selected from one of polygon mesh structure disclosed in FIGS. 5A & 5B, body-centered cubic structure disclosed in FIGS. 6A and 6B, face-centered cubic structure disclosed in FIGS. 7A and 7B, circular cubic structure disclosed in FIG. 8, rectangular cubic structure disclosed in FIG. 9 or other cubic geometry structures.

Referring to FIGS. 1 and 4, in other embodiment, pore size of the first pores 111a is able to be larger than that of the second pores 112a to make the first porosity of the first ventilating portion 111 being higher than the second porosity of the second ventilating portion 112 by changing pore sizes of the first pores 111a and the second pores 112a under the conditions of same volume and pore number. With reference to FIG. 1, pore size of the first pores 111a is limited between 200 um and 300 um when forming the first ventilating portion 111. With reference to FIG. 2, pore size of the second pores 112a is limited between 100 um and 200 um when forming the second ventilating portion 112, thus making the first porosity of the first ventilating portion 111 higher than the second porosity of the second ventilating portion 112.

With reference to FIG. 4, the porous body 110 of the present invention is made by additive manufacturing method, and the first porosity of the first ventilating portion 111 is higher than the second porosity of the second ventilating portion 112 for throttling. In addition, the flowing directions and pore sizes of the first pores 111a and the second pores 112a are controllable because the porous body 110 is made by additive manufacturing method. Outlet air or fluid pressure of the porous aerostatic carrier 100 is able to be even when air or fluid enters into the first ventilating portion 111 and passes through the second ventilating portion 112. When the porous aerostatic carrier 100 is mounted on a carrying stage (not shown in Figure), the porous aerostatic carrier 100 is able to prevent the carrying stage moving along a track (not shown in Figure) from shaking to enhance moving stability of the carrying stage.

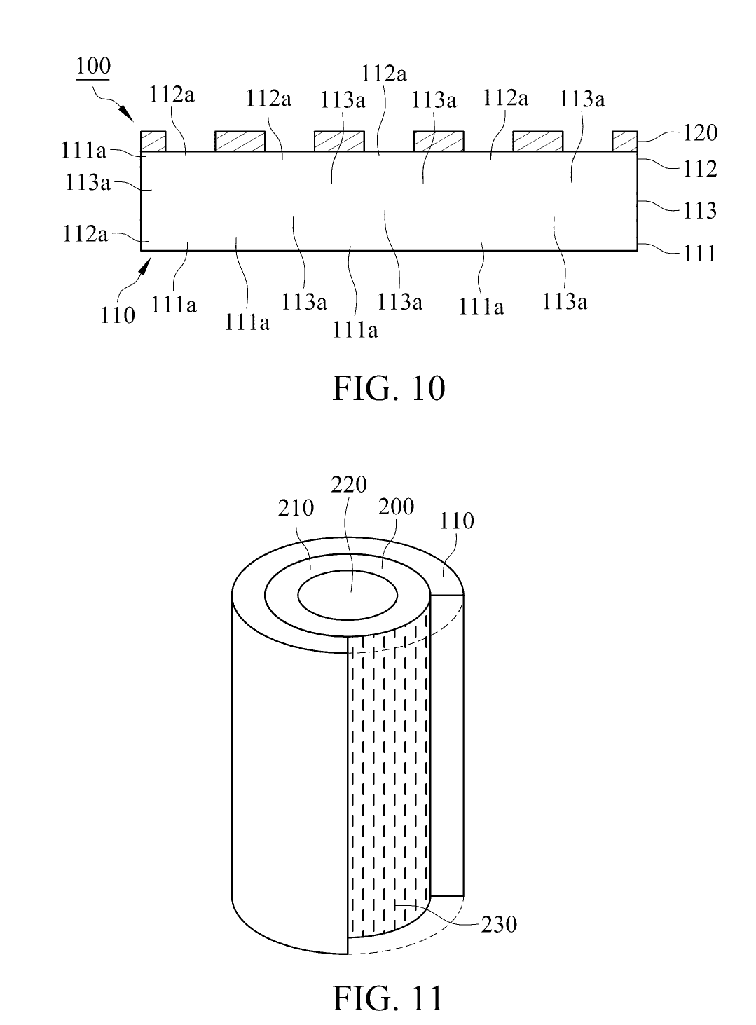

A second embodiment of the present invention is illustrated in FIG. 10, the primary difference between the first and second embodiments is that the porous body 110 further comprises a third ventilating portion 113 in the second embodiment. The third ventilating portion 113 located between the first ventilating portion 111 and the second ventilating portion 112 includes a plurality of third pores 113a, and the material of the third ventilating portion 113 is selected from metallic materials such as aluminum alloy, stainless steel, die steel, titanium alloy, nickel alloy, copper alloy and cobalt-chromium alloy. Preferably, the first ventilating portion 111, the second ventilating portion 112 and the third ventilating portion 113 are made by the same material and formed as one piece. The third pores 113a communicate with the first pores 111a and the second pores 112a located at two sides of the third ventilating portion 113 respectively, and a third porosity of the third ventilating portion 113 decreases gradually from the first ventilating portion 111 toward the second ventilating portion 112. In this embodiment, pore sizes of the first pores 111a, the second pores 112a and the third pores 113a are substantially the same, and the third porosity enables to be defined by Vv3/Vt3 in advance (Vv3 is the volume of the third pores 113a, Vt3 is the apparent volume of the third ventilating portion 113).

With reference to FIG. 10, the porous body 110 of the present invention is made by additive manufacturing method, the first porosity of the first ventilating portion 111 is higher than the second porosity of the second ventilating portion 112, and the third porosity of the third ventilating portion 113 decreases gradually from the first ventilating portion 111 toward the second ventilating portion 112 for throttling. Besides, flowing directions and pore sizes of the first pores 111a, the second pores 112a and the third pores 113a are controllable because the porous body 110 is made by additive manufacturing method. Outlet air or fluid pressure of the porous aerostatic carrier 100 is able to be even when air or fluid enters into the first ventilating portion 111 and passes through the third ventilating portion 113 and the second ventilating portion 112 sequentially. When the porous aerostatic carrier 100 is mounted on a carrying stage (not shown in Figure), the porous aerostatic carrier 100 is able to prevent the carrying stage moving along a track (not shown in Figure) from shaking to enhance moving stability of the carrying stage.

Referring to FIG. 11, the porous body 110 of the present invention is able to be formed on a shaft 200, wherein the shaft 200 comprises a body 210, a channel 220 and a plurality of penetration holes 230. The body 210 surrounds the channel 220, the penetration holes 230 penetrate through the body 210 and communicate with the channel 220, and the porous body 110 is formed on the body 210. Similarly, outlet air or fluid pressure of the porous aerostatic carrier 100 is able to be even to make the shaft 200 having higher stability in rotation when air or fluid passes through the penetration holes 230 via the channel 220 to enter the porous body 110.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. A porous aerostatic carrier includes:
a porous body made by additive manufacturing method comprises a first ventilating portion and a second ventilating portion, the first ventilating portion includes a plurality of first pores, the second ventilating portion includes a plurality of second pores communicating with the first pores, wherein a plurality of micro channels are composed of the first pores and the second pores, and a first porosity of the first ventilating portion is higher than a second porosity of the second ventilating portion; and
a sealing layer covering the second ventilating portion comprises a plurality of through holes, wherein the through holes reveal parts of the second pores.

2. The porous aerostatic carrier in accordance with claim 1, wherein the first ventilating portion and the second ventilating portion are formed as one piece.

3. The porous aerostatic carrier in accordance with claim 1, wherein the porous body further comprises a third ventilating portion including a plurality of third pores, the third ventilating portion is located between the first ventilating portion and the second ventilating portion, the third pores communicate with the first pores and the second pores, and a third porosity of the third ventilating portion decreases gradually from the first ventilating portion toward the second ventilating portion.

4. The porous aerostatic carrier in accordance with claim 3, wherein the first ventilating portion, the second ventilating portion and the third ventilating portion are formed as one piece.

5. The porous aerostatic carrier in accordance with claim 1, wherein pore sizes of the first pores and the second pores are substantially the same.

6. The porous aerostatic carrier in accordance with claim 3, wherein pore sizes of the first pores, the second pores and the third pores are substantially the same.

7. The porous aerostatic carrier in accordance with claim 5, wherein pore size of the first pores is between 100 um and 300 um.

8. The porous aerostatic carrier in accordance with claim 6, wherein pore size of the first pores is between 100 um and 300 um.

9. The porous aerostatic carrier in accordance with claim 1, wherein the first porosity is between 0.3 and 0.4.

10. The porous aerostatic carrier in accordance with claim 1, wherein the second porosity is between 0.15 and 0.25.

11. The porous aerostatic carrier in accordance with claim 9, wherein the second porosity is between 0.15 and 0.25.

12. The porous aerostatic carrier in accordance with claim 1, wherein pore size of the first pores is larger than that of the second pores.

13. The porous aerostatic carrier in accordance with claim 1, wherein pore size of the first pores is between 200 um and 300 um.

14. The porous aerostatic carrier in accordance with claim 13, wherein pore size of the second pores is between 100 um and 200 um.

15. A porous body made by additive manufacturing method comprises a first ventilating portion and a second ventilating portion, wherein the first ventilating portion includes a plurality of first pores, the second ventilating portion includes a plurality of second pores communicating with the first pores, and a plurality of micro channels are composed of the first pores and the second pores, wherein a first porosity of the first ventilating portion is higher than a second porosity of the second ventilating portion.

16. The porous body in accordance with claim 15, wherein the first ventilating portion and the second ventilating portion are formed as one piece.

17. The porous body in accordance with claim 15 further comprises a third ventilating portion including a plurality of third pores, the third ventilating portion is located between the first ventilating portion and the second ventilating portion, the third pores communicate with the first pores and the second pores, wherein a third porosity of the third ventilating portion decreases gradually from the first ventilating portion toward the second ventilating portion.

18. The porous body in accordance with claim 17, wherein the first ventilating portion, the second ventilating portion and the third ventilating portion are formed as one piece.

19. The porous body in accordance with claim 15, wherein pore sizes of the first pores and the second pores are substantially the same.

20. The porous body in accordance with claim 17, wherein pore sizes of the first pores, the second pores and the third pores are substantially the same.

21. The porous body in accordance with claim 18, wherein pore size of the first pores is between 100 um and 300 um.

22. The porous body in accordance with claim 20, wherein pore size of the first pores is between 100 um and 300 um.

23. The porous body in accordance with claim 15, wherein the first porosity is between 0.3 and 0.4.

24. The porous body in accordance with claim 15, wherein the second porosity is between 0.15 and 0.25.

25. The porous body in accordance with claim 23, wherein the second porosity is between 0.15 and 0.25.

26. The porous body in accordance with claim 15, wherein pore size of the first pores is larger than that of the second pores.

27. The porous body in accordance with claim 15, wherein pore size of the first pores is between 200 um and 300 um.

28. The porous body in accordance with claim 27, wherein pore size of the second pores is between 100 um and 200 um.
